(19) United States
(12) Patent Application Publication
(10) Pub. No.: US 2026/0080297 A1
(43) Pub. Date: Mar. 19, 2026

(54) TRAINING MACHINE LEARNING MODELS USING CUSTOMER INTERACTION DATA

(71) Applicant: Netflix, Inc., Los Gatos, CA (US)

(72) Inventors: Denny Stohr, Saratoga, CA (US); Ryan Andrew Chi, Cupertino, CA (US)

(21) Appl. No.: 18/884,898

(22) Filed: Sep. 13, 2024

(51) Int. Cl. G06N 20/00; G06Q 50/10

(52) U.S. Cl. CPC G06N 20/00; G06Q 50/10

(57) ABSTRACT

A computer-implemented method includes accessing natural language dialogue data gathered from interactions between an entity and a user. The method further includes accessing contextual information related to the user, which provides additional indications of the user's consumption of the service. The method further includes training a machine learning model to generate structured data that is assembled according to a schema that prepares the structured data for aggregation into clusters, training the machine learning model to aggregate the data into clusters, where each cluster includes an identified standard that defines inclusion in the cluster, training the machine learning model to map the aggregated, structured data to a specified technical issue related to the service that is to be resolved and, based on the mapping, providing an indication of the specified technical issue that is to be resolved to a computing device. Various other methods, systems, and computer-readable media are also disclosed.

### BACKGROUND

Quality of Experience (QoE) metrics are used to ensure a satisfactory playback experience for users. In video streaming services, for example, QoE metrics may be used to determine whether the user's requested videos played back successfully and whether there were any issues during playback. These QoE metrics are typically system-centric, focusing on data transmission aspects such as rebuffer rate, play delay, and error rates. Many user-centric pain points, however, remain unobservable through traditional system-centric QoE metrics. As such, these issues often remain unidentified or unresolved within the system for extended periods of time.

### SUMMARY

As will be described in greater detail below, the present disclosure generally describes systems and methods for training machine learning models to analyze user-derived natural language inputs in order to identify technical issues for resolution.

In one example, a computer-implemented method is provided for training a machine learning model to identify technical issues for resolution from natural language inputs. The method includes accessing data that includes natural language dialogue gathered from multiple interactions between an entity and a user, where the user consumes a service provided by the entity. The method also includes accessing contextual information related to the user, where the contextual information provides additional indications of the user's consumption of the service provided by the entity. Still further, the method includes training a machine learning model to generate structured data that is assembled according to a specified schema that prepares the structured data for aggregation into clusters. The method also includes training the machine learning model to aggregate the data into clusters, where each cluster includes an identified standard that defines inclusion in the cluster. The method further includes training the machine learning model to map the aggregated, structured data to a specified technical issue related to the service that is to be resolved and then, based on the mapping, providing an indication of the specified technical issue that is to be resolved to one or more different entities.

In some embodiments, the indication of the specified technical issue that is to be resolved includes a human-readable description of the technical issue related to the service that is to be resolved. In some cases, the indication of the specified technical issue that is to be resolved further includes multiple service consumption statistics related to the specified technical issue. In some examples, the machine learning model is further trained to identify which service consumption statistics are most relevant for inclusion in the indication of the specified technical issue.

In some cases, the accessed data that includes natural language dialogue is a chat transcript or a voice transcript. In some embodiments, the chat transcripts or voice transcripts are accessed from a plurality of different types of support interactions for the service. In some examples, the machine learning model is a large language model (LLM).

In some cases, generating the structured data includes determining how the LLM has been trained and altering the structured data based on the determination. In some examples, the structured data is altered to a form that is more similar to what the LLM has previously processed (and thus learned on) as training data. In some embodiments, the indication of the specified technical issue that is to be resolved further includes an indication of priority for the technical issue. In some examples, the machine learning model is further trained to filter noise from the natural language dialogue. In some cases, the machine learning model is further trained to identify, from the natural language dialogue, which electronic device the user is using, and wherein the indication of the specified technical issue includes an indication of a hardware-specific technical issue related to the identified electronic device.

In some embodiments, the machine learning model is further trained or fine-tuned to determine how the specified technical issue is related to cancellations of the service. In some examples, the machine learning model analyzes a specified timeframe after the technical issue occurs to determine whether cancellations occur during that timeframe. In some cases, the specified technical issue is mapped to an error code used by the service to identify a specific error. In some embodiments, the indication of the specified technical issue includes the mapped error code, various statistics related to the error code, and a plain-language summary of the technical issue generated by the machine learning model. In some cases, the machine learning model is further trained to identify at least one possible resolution to the specified technical issue. In some examples, the method further includes providing the identified possible resolution(s) to an entity.

A corresponding system includes at least one physical processor and physical memory including computer-executable instructions that, when executed by the physical processor, cause the physical processor to: access data that includes natural language dialogue gathered from multiple interactions between an entity and a user, where the user consumes a service provided by the entity. The processor then accesses contextual information related to the user, where the contextual information provides additional indications of the user's consumption of the service provided by the entity. The processor also trains a machine learning model to generate structured data that is assembled according to a specified schema that prepares the structured data for aggregation into clusters and trains the machine learning model to aggregate the data into clusters, where each cluster includes an identified standard that defines inclusion in the cluster. The processor further trains the machine learning model to map the aggregated, structured data to a specified technical issue related to the service that is to be resolved and, based on the mapping, provides an indication of the specified technical issue that is to be resolved to at least one computing device.

In some examples, a corresponding non-transitory computer-readable medium is provided that includes one or more computer-executable instructions that, when executed by at least one processor of a computing device, cause the computing device to: access data that includes natural language dialogue gathered from multiple interactions between an entity and a user, where the user consumes a service provided by the entity. The processor then accesses contextual information related to the user, where the contextual information provides additional indications of the user's consumption of the service provided by the entity. The processor also trains a machine learning model to generate structured data that is assembled according to a specified schema that prepares the structured data for aggregation into clusters and trains the machine learning model to aggregate the data into clusters, where each cluster includes an identified standard that defines inclusion in the cluster. The processor further trains the machine learning model to map the aggregated, structured data to a specified technical issue related to the service that is to be resolved and, based on the mapping, provides an indication of the specified technical issue that is to be resolved to at least one computing device.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an example computer architecture in which the embodiments described herein may operate.

FIG. 2 illustrates a flow diagram of an exemplary method for training a machine learning model to identify technical issues for resolution from natural language inputs.

FIG. 3 illustrates an alternative example computer architecture in which the embodiments described herein may operate.

FIG. 4 illustrates an alternative example computer architecture in which the embodiments described herein may operate.

FIG. 5 illustrates an embodiment outlining various methods of evaluating a cluster while training a machine learning model.

FIG. 6 illustrates an embodiment illustrating an example interface in which identified technical issues and corresponding contextual information are presented.

FIG. 7 is a block diagram of an exemplary content distribution ecosystem.

FIG. 8 is a block diagram of an exemplary distribution infrastructure within the content distribution ecosystem shown in FIG. 7.

FIG. 9 is a block diagram of an exemplary content player within the content distribution ecosystem shown in FIG. 8.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to training machine learning (ML) models to identify technical issues for resolution using natural language inputs. In some cases, ML models are further trained and implemented to identify potential resolutions for the identified technical issues.

As noted above, media streaming services often implement quality of experience (QoE) metrics to determine whether users of the service are having a positive streaming experience. These metrics may include the client device's rebuffer rate, an indication of play delay, a product quality score that indicates how well the streamed content was provided to the client device, or other indicators. Such QoE metrics may be measurable from the service provider's servers or may be measured from the data traffic sent to the client device (e.g., a television or smartphone). At least in some cases, however, the QoE metrics may not be able to determine whether playback or navigational issues have occurred on the client device. For instance, user-centric technical issues may occur without a clear view, from the server's perspective, of what is going on. Such user-centric issues may include non-functional pause buttons, audio and video synchronization problems, high dynamic range (HDR) settings causing excessively dark colors, or other errors.

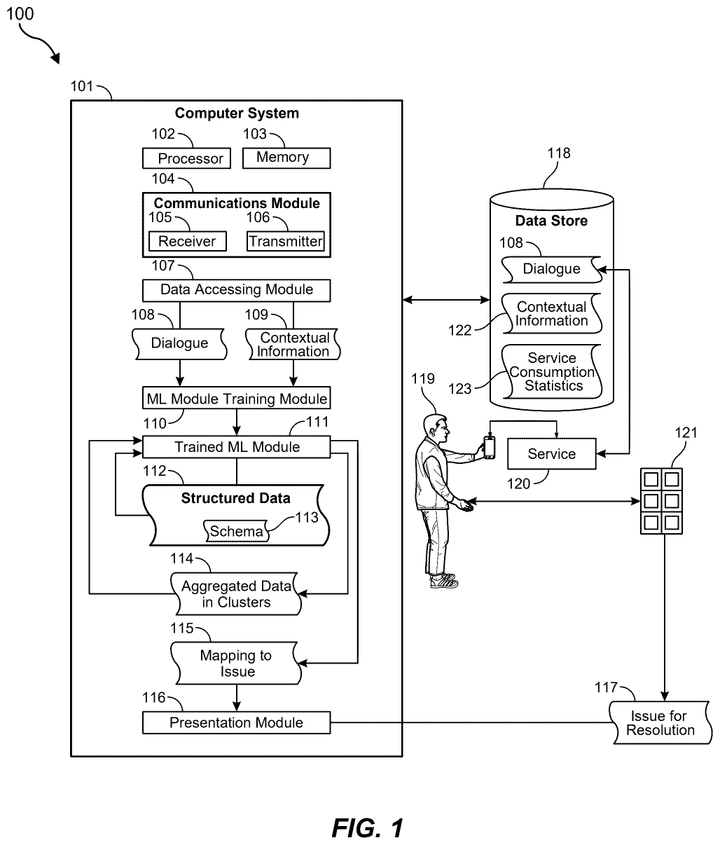

To address these client-side technical issues that prevent the user from having a high quality of experience, the systems described herein may be configured to train machine learning models to mine user-provided data to complement other system-centric QoE metrics. At least in some cases, this may be achieved by inferring preferences from user behavior, including both prompted and unprompted user feedback. In one example, customer service (CS) chat transcripts may be used as a source of unprompted user feedback. These CS chat transcripts may represent hundreds or thousands of interactions (or more) between users and a media streaming provider (or other entity). Extracting precise and actionable technical insights from these CS chat transcripts can provide a deeper understanding of client device technical issues and may further identify technical issues that are not directly observable through system-centric QoE metrics. These processes will be described in greater detail below with reference to FIGS. 1-9.

FIG. 1, for example, illustrates a computing environment 100 in which machine learning models may be trained to identify technical issues for resolution using natural language inputs. FIG. 1 includes various electronic components and elements including a computer system 101 that is used, alone or in combination with other computer systems, to perform associated tasks. The computer system 101 may be substantially any type of computer system including a local computer system or a distributed (e.g., cloud) computer system. The computer system 101 includes at least one processor 102 and at least some system memory 103. The computer system 101 includes program modules for performing a variety of different functions. The program modules may be hardware-based, software-based, or may include a combination of hardware and software. Each program module uses computing hardware and/or software to perform specified functions, including those described herein below.

In some cases, the communications module 104 is configured to communicate with other computer systems. The communications module 104 includes substantially any wired or wireless communication means that can receive and/or transmit data to or from other computer systems. These communication means include, for example, hardware radios such as a hardware-based receiver 105, a hardware-based transmitter 106, or a combined hardware-based transceiver capable of both receiving and transmitting data. The radios may be WIFI radios, cellular radios, Bluetooth radios, global positioning system (GPS) radios, or other types of radios. The communications module 104 is configured to interact with databases, mobile computing devices (such as mobile phones or tablets), embedded computing systems, or other types of computing systems.

The computer system 101 further includes a data accessing module 107. The data accessing module 107 may be configured to access various types of data. The data may include text files, audio files, video files, bulk data, or other types of data. In some cases, the data accessed by the data accessing module 107 may include natural language dialogue 108. The dialogue may include chat transcripts, phone conversation transcripts, written text describing an interaction, audio recordings, video recordings, or other recorded dialogue. At least in some cases, the natural language dialogue 108 may represent chat transcripts from customer support chats or phone conversations that occur between a user and an entity such as a media streaming entity.

For example, in FIG. 1, an entity 121 may provide a service 120 to a client or user 119. In some embodiments, the entity 121 may be a media streaming service that provides a media streaming service 120 to the user 119. The media streaming service may implement quality of experience metrics to determine how well the media is being provisioned to the user. At least in some cases, the systems described herein may detect further technical issues experienced on the client device that are not detectable using traditional QoE metrics.

In order to do this, the systems herein may additionally access contextual information 109. The contextual information 109 may be implemented, in addition to and in conjunction with the QoE metrics. The contextual information 109 may be used to identify various technical issues that are experienced by the user 119 on their client device. These client devices may include a wide range of electronic devices, including smartphones, smart televisions, laptops, tablets, wearable devices (e.g., smartwatches), gaming stations, streaming stick devices, or other electronic devices that may be used for media streaming and/or media playback. The contextual information 109 (which may be different than or the same as previously stored contextual information 122) may be contained in a local or remote (e.g., cloud-based) data store 118.

The ML model training module 110 of computer system 101 may be implemented to train one or more ML models 111 to generate structured data 112 that is organized, formatted, or otherwise arranged according to a specified schema 113. The schema may be applied in a manner that allows the structured data 112 to be aggregated into clusters 114 based on various criteria or standards that define inclusion in the cluster. Data that meet a given standard or criterion are included in the cluster. These aggregated data clusters 114 may then be mapped to various technical issues 115 that have been experienced on client playback devices. Once the technical issues have been identified from the combination of natural language dialogue and contextual information 109, the presentation module 116 may provide the technical issues 117 to the entity 121 and or to other computer systems or persons. These concepts will be described in greater detail with respect to method 200 of FIG. 2 and FIGS. 1-9 below.

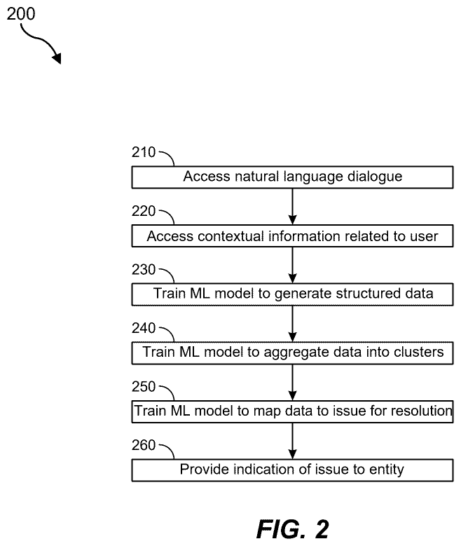

FIG. 2 is a flow diagram of an exemplary computer-implemented method 200 for training a machine learning model to identify issues for resolution using user-derived natural language inputs. The steps shown in FIG. 2 may be performed by any suitable computer-executable code and/or computing system, including the systems illustrated in FIG. 1. In one example, each of the steps shown in FIG. 2 may represent an algorithm whose structure includes and/or is represented by multiple sub-steps, examples of which will be provided in greater detail below.

Method 200 includes, at 210, a step for accessing data that includes natural language dialogue 108 gathered from multiple interactions between an entity 121 and a user 119, where the user consumes a service 120 provided by the entity. At step 220, the method includes accessing contextual information 109 related to the user 119. The contextual information 109 provides additional indications of the user's consumption of the service 120 that is provided by the entity 121. At step 230, the method 200 includes training a machine learning model 111 to generate structured data 12 that is assembled according to a specified schema 113 that prepares the structured data for aggregation into clusters 114.

At step 240, the method 200 includes training the machine learning model 111 to aggregate the data into clusters 114, where each cluster includes an identified standard that defines inclusion in the cluster. At step 250, method 200 includes training the machine learning model to map the aggregated, structured data to a specified issue 117 (via mapping 115) related to the service that is to be resolved. And, at step 260, method 200 includes providing, based on the mapping 115, an indication of the specified issue 117 that is to be resolved to at least one computing device associated with the entity 121 or with another entity.

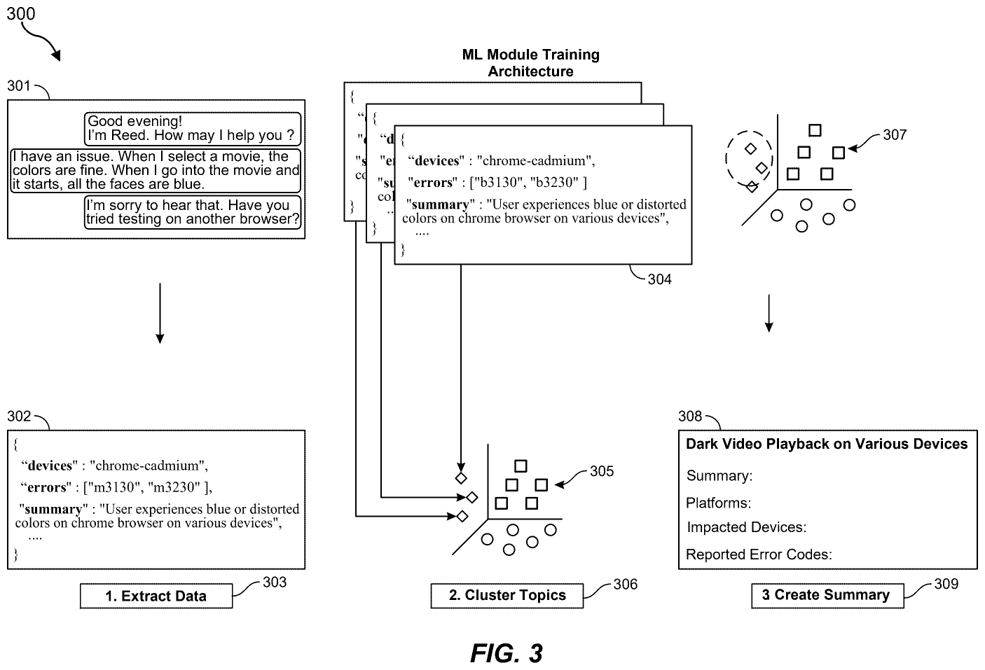

The method 200 may be implemented within the ML model training architecture 300 of FIG. 3. The ML model training architecture 300 may be configured to train and/or implement machine learning models. At least in some embodiments, the ML model training architecture 300 may be configured to extract data 303 from various sources. For instance, the ML models may be trained to extract data from natural language dialogue (e.g., 301 of FIG. 3 or 108 of FIG. 1). The natural language dialogue 301 may include chat transcripts or voice transcripts and, in some cases, those transcripts may come from customer support interactions. For instance, when a media streaming service provider is provisioning media files over the internet, technical issues may arise that need to be resolved in order for the customer to continue using the platform. The customer may reach out to the service provider and engage in a written chat or voice conversation with a customer service representative. The customer service representative may ask the customer questions such as which electronic playback device the customer is using, which errors the customer is seeing, or other related information 302.

The machine learning models may be trained to analyze the natural language dialogue 301 and extract important and useful details. The ML models may be trained, over time, to recognize which details are most beneficial and determinative when identifying technical issues, either with the streaming provider's media provisioning service, the client playback application, or the client's playback device itself. Those details that are determined to be most important to or helpful in the identification of technical issues may be flagged for further use, Other details and information may be identified as less important or as noise that is to be filtered out.

In some cases, the embodiments herein may be configured to process the accessed data before it is used in the ML models. For example, in some cases, the systems herein may anonymize user data (e.g., from recorded chat transcripts) and may implement other data minimization strategies. These systems may use algorithmic heuristics to identify and clean personally identifiable information (PII) from chat transcripts or other materials before using those materials in the ML models. In some cases, these systems may implement a zero-data retention policy where any ML engines or artificial intelligence that access the data agree not to retain any of the information that is uploaded to them. Moreover, these systems may specifically include instructions in prompts to redact or remove any other PII that was not previously detected. In this manner, the systems herein may help to ensure that users'PII is not used in the analysis or other steps described in the processes herein. These systems may also help to ensure that the amount of data accessed by the models is minimized to enhance ML model efficiency.

The ML model training architecture 300 may then train the ML models to analyze the extracted data 304 and aggregate the extracted data into clusters 305 or cluster topics 306. Each cluster 305 may represent a particular type of technical issue. For instance, one cluster may represent technical issues related to the media streaming provider's servers or communications networks. Another cluster may represent technical issues related to client devices or specific models of client devices. Another cluster may represent technical issues related to specific hardware such as processors, encoders, memory, or other electrical components that may apply across multiple brands or device models that share those components. Other clusters may represent technical issues related to the client playback application including subclusters for different versions of the client application.

Once the identified technical issues have been aggregated into clusters or subclusters, the ML model training architecture 300 may then train the ML models to identify common characteristics among the technical issues in the cluster 307 and generate a plain language summary 309 of the technical issues for that cluster. For instance, the summary 309 may include a title such as “Dark Video Playback on Various Devices” 308. The summary may include different sections including, for example, a summary of the technical issue (e.g., dark video playback), an indication of which platforms (e.g., operating systems) are experiencing the issue, which client playback devices are experiencing the issue, which error codes are surfacing, etc. Some or all of this information may be gleaned from the natural language dialogue 301 that was analyzed at the beginning of the process. Indeed, the ML model training architecture 300 may train ML models to extract specific data from the natural language dialogue, aggregate that data, and analyze the aggregated data to create a technical issue summary 309 that includes information that will be most helpful in resolving the technical issue. In some cases, based on previously identified issues and their resolutions, the ML models may be trained to generate and offer potential solutions to the technical issues presented in the summaries.

As noted above, many of the embodiments described herein may be designed to train and/or implement machine learning models. For example, at least some embodiments herein may implement one or more machine learning algorithms to analyze the information accessed from the various data sources to learn which information is most relevant to a specified outcome (e.g., extracting natural language data that will be most helpful in identifying a technical playback issue in a customer device). In some cases, the systems herein may be configured to train a neural network to identify which information is to be altered to lead to a desired outcome. Moreover, the systems herein may be configured to train a neural network to determine how to alter the identified information to lead to that desired outcome.

In some examples, for instance, one or more different machine learning algorithms may be implemented to find specific data or to find specific data from a specific data source. The ML algorithms may be configured to access data, interpret that data, and learn from the discovered data. Then, based on the discovered data, the ML algorithms may be modified to better find the data in future searches. For example, if ML algorithms are implemented to find different pricing for different items in different states or in different countries, the pricing for each item may be noted, along with the location, date, time, seller, and other info. Future ML algorithms may be altered to rank certain sellers or certain locations or certain price structures above (or below) others. Moreover, the ML algorithms may be modified to perform the data searches in different manners that search different databases, that perform the searches using different search criteria, that apply search preferences in a different manner, or are otherwise changed to provide a desired outcome.

In some embodiments, the ML algorithms may be modified based on which types of data are retrieved from a given data source. Thus, for example, if producer prices are retrieved or if curator wholesale prices are retrieved, or if retail prices are retrieved, the ML algorithms may be modified in different manners. The modifications may be tuned and calibrated to find each specific type of data. Then, future data searches using the altered ML algorithms may be performed faster and with greater reliability.

Still further, the ML algorithms may be modified based on the amount of data retrieved from the various data sources. For instance, some repositories may include large amounts of natural language dialogue or other data, while other repositories include less of that type of data. The ML algorithms may be altered to prefer known good repositories and to find other potentially valuable repositories that include the data sought for. The ML algorithms may be continually updated to optimize the manner in which the identified information is altered to lead to a specified outcome. Thus, over time, the ML algorithms may continue to learn and to be modified based on the information learned. New search techniques and newly found data repositories may cause small or large changes to be made to the ML algorithms, helping them to operate more efficiently and to return more usable results.

The systems herein may implement and/or incorporate a machine learning module that includes various ML-related components. These components may include a machine learning (ML) processor, an inferential model, a feedback implementation module, a prediction module, a large language model (LLM), and/or a neural network. Each of these components may be configured to perform different functions with respect to training and/or implementing a machine learning model. The ML processor, for example, may be a dedicated, special-purpose processor with logic and circuitry designed to perform machine learning. The ML processor may work in tandem with the feedback implementation module to access data and use feedback to train an ML model. For instance, the ML processor may access one or more different training data sets. The ML processor and/or the feedback implementation module may use these training data sets to iterate through positive and negative samples and improve the ML model over time.

In some cases, the machine learning module may include an inferential model. As used herein, the term “inferential model” may refer to purely statistical models, purely machine learning models, or any combination of statistical and machine learning models. Such inferential models may include neural networks such as recurrent neural networks. In some embodiments, the recurrent neural network may be a long short-term memory (LSTM) neural network. Such recurrent neural networks are not limited to LSTM neural networks and may have any other suitable architecture.

For example, in some embodiments, the neural network may be a fully recurrent neural network, a gated recurrent neural network, a recursive neural network, a Hopfield neural network, an associative memory neural network, an Elman neural network, a Jordan neural network, an echo state neural network, a second order recurrent neural network, and/or any other suitable type of recurrent neural network. In other embodiments, neural networks that are not recurrent neural networks may be used. For example, deep neural networks, convolutional neural networks, and/or feedforward neural networks, may be used. In some implementations, the inferential model may be an unsupervised machine learning model, e.g., where previous data (on which the inferential model was previously trained) is not required. In some cases, large language models may be used which are based on language models with a large parameter count and include multiple neural network layers. Still further, in some cases, state space models may be implemented to perform specified functions as a potential alternative to large language models.

At least some of the embodiments described herein may include training a neural network to identify data dependencies, identify which information from various data sources is to be altered to lead to a desired outcome, or how to alter the information to lead to a desired outcome. In some embodiments, the systems described herein may include a neural network that is trained to identify how information is to be altered using different types of data and associated data dependencies. For example, the embodiments herein may use a feed-forward neural network. In some embodiments, some or all of the neural network training may happen offline. Additionally or alternatively, some of the training may happen online. In some examples, offline development may include feature and model development, training, and/or test and evaluation.

In one embodiment, a repository that includes data about past data accessed and past data alterations may supply the training and/or testing data. In one example, when the underlying system had accessed different types of data from different data sources, the system may determine which alterations to identify based on data from a feature repository and/or an online recommendation model that may be informed by the results of offline development. In one embodiment, the output of the machine learning model may include a collection of vectors of floats, where each vector represents a data source and each float within the vector represents the probability that a specified data alteration will be identified. In some embodiments, the recent history of a data source may be weighted higher than older history data. For example, if a data source had repeatedly provided relevant data that resulted in relevant operational steps, the ML model may determine that the probability of that data source providing relevant data in the future is higher than for other data sources.

Once the machine learning model has been trained, the ML model may be used to identify which data is to be altered and how that data is to be altered based on multiple different data sets. In some embodiments, the machine learning model that makes these determinations may be hosted on different cloud-based distributed processors (e.g., ML processors) configured to perform the identification in real time or substantially in real time. Such cloud-based distributed processors may be dynamically added, in real time, to the process of identifying data alterations. These cloud-based distributed processors may work in tandem with the prediction module to generate outcome predictions, according to the various data inputs. These predictions may identify potential outcomes that would result from the identified data alterations. The predictions output by the prediction module may include associated probabilities of occurrence for each prediction.

The prediction module may be part of a trained machine learning model that may be implemented using the ML processor. In some embodiments, various components of the machine learning module may test the accuracy of the trained machine learning model using, for example, proportion estimation. This proportion estimation may result in feedback that, in turn, may be used by the feedback implementation module in a feedback loop to improve the ML model and train the model with greater accuracy.

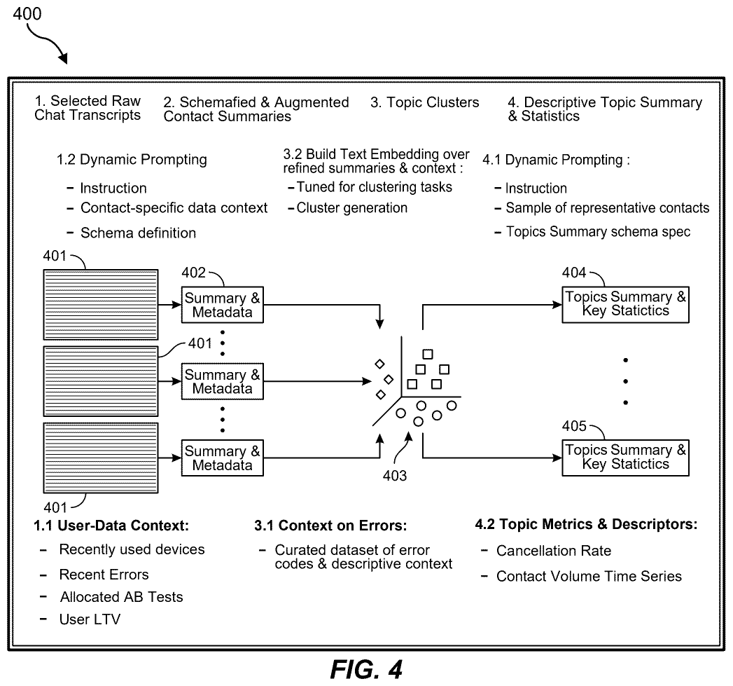

FIG. 4 illustrates a workflow 400 in which natural language dialogue is analyzed, structured (schematized), aggregated into clusters, and then used to generate a technical issue summary. For instance, at step 1, raw chat transcripts 401 may be accessed (e.g., by data accessing module 107 of FIG. 1). The raw chat transcripts 401 may include interactions (e.g., questions and answers) between customers and customer service representatives. At least in some cases, at step 1.1, the underlying system may access and/or identify contextual information related to the customer or user. This may include recently used devices, recent errors experienced on their client device, an indication of whether the user was part of an A/B test, a user's history with the media service company, or other information that may provide context for an error that the user is experiencing.

The raw chat transcripts 401 may be analyzed and structured, in light of and with reference to the user-related contextual information accessed at step 1.1, according to a specified schema. At step 1.2, the system may provide dynamic prompting that includes user-specific instructions based on user-specific context data. The system may then generate, at step 2, a transcript summary and corresponding metadata 402 that is structured according to the specified schema. The resulting data structure (including the summary and metadata 402) may be arranged or assembled in a manner that allows the system to aggregate and arrange the data into clusters 403. At step 3, the chat summaries and corresponding metadata are aggregated into topic clusters 403.

At step 301, the system may train the ML models to access company-specific contextual information related to the errors that were identified from the natural language dialogue (e.g., chat transcripts 401). The company-specific contextual information may include error codes and/or descriptive context for the errors, explaining what the errors are and where the errors are typically experienced. At step 3.2, the system may generate text embeddings, which are applied to the summaries 402. The updated summaries may be tailored to each cluster, highlighting features that are important for client device errors, client application errors, server errors, or other types of errors.

At step 4, the ML models may be trained to generate descriptive topic summaries and statistics using the company-specific contextual information related to the errors and the generated text embeddings for the various clusters. At step 4.1, dynamic prompting may be used to generate a sample of representative scenarios and instructions for generating a topic summary. The system may determine, at step 4.2, various topic metrics and descriptors for the summaries, including cancellation rate based on the error, contact volume time, or other metrics. These metrics and aggregated, schematized data may be used to generate topic summaries and key statistics 404 and/or 405.

Thus, after multiple customers interact with customer service, those interactions may be analyzed and broken down into identifiable technical issues. These identified technical issues can then be presented to the media streaming service or to other entities for resolution. In some cases, the ML models may be further trained to generate and present potential solutions to the technical issues based on past, identified issues and based on the successful resolutions to those issues. In this manner, over time, machine learning models may become increasingly good at learning which natural language from a transcript is most important to identifying a technical issue, structuring the data in a manner that allows for aggregation into clusters, aggregating that data into clusters, and generating plain language summaries of the technical issues for consumption by the service-providing entity.

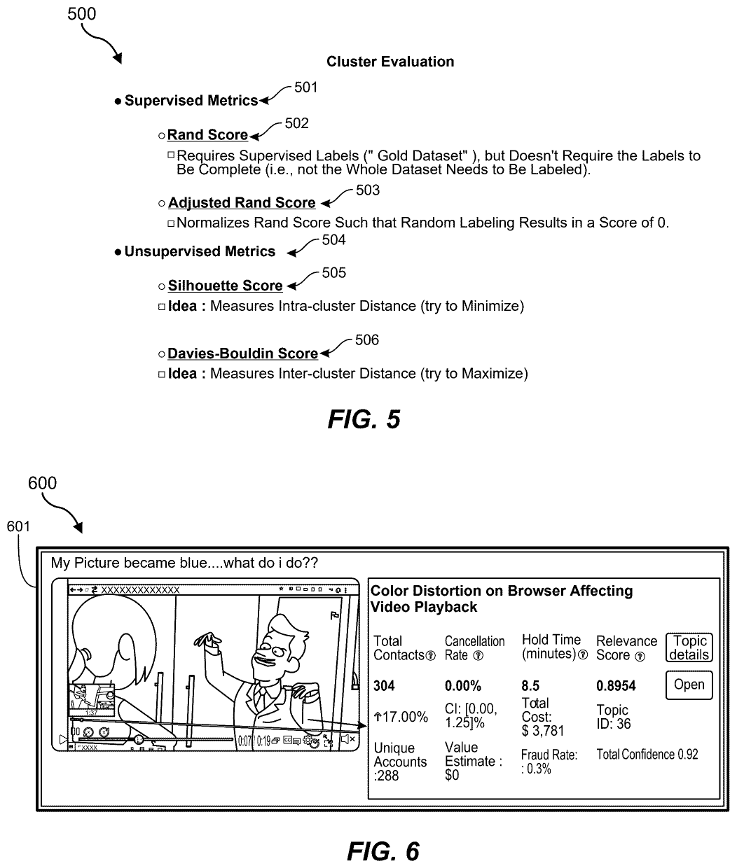

As part of this process, the machine learning models may implement multiple different kinds of metrics. For instance, the machine learning models may implement supervised metrics 501 and/or unsupervised metrics 504, as indicated in FIG. 5. During the cluster evaluation process 500 in which various structured data has been aggregated into different clusters based on the type of technical issue that has been identified, the ML models may implement supervised metrics 501 or unsupervised metrics 504 to determine which cluster a given issue belongs to and whether a given grouping of technical issues is proper. One of the supervised metrics 501 that may be used in this process is a Rand score 502. The Rand score 502 may implement supervised labels (e.g., “gold dataset”) for some of the data, but not all of the dataset needs to be labeled to be analyzed as part of the Rand score supervised metric.

Additionally or alternatively, an adjusted Rand score 503 may be implemented, in which the underlying system normalizes the Rand score so that random labeling results in a score of zero for the cluster. Unsupervised metrics 504 may include a silhouette score 505 that measures intra-cluster distance with an attempt to minimize distance between results within a cluster, while the Davies-Bouldin score 506 may be implemented to measure inter-cluster distance with an attempt to maximize distance between clusters. Thus, results within a cluster are more tightly grouped and more solidly identified as belonging to the cluster, while separate clusters are more clearly and definitively separated. These supervised and unsupervised metrics may be implemented to provide greater accuracy when aggregating the structured data into clusters. Moreover, the more accurately clustered data may then provide a clearer identification of the technical issue being experienced by customers.

FIG. 6 illustrates an embodiment of a user interface 600 that illustrates an example of what may be shown to an engineer or customer service representative of a media streaming entity. This user interface 600 may include or may itself be the issue for resolution 117 prepared by the presentation module 116 of FIG. 1. The user interface 600 may include an image of the technical issue, along with a heading that outlines the problem (e.g., “My picture became blue . . . what do I do?”). The user interface 600 may provide an image that illustrates the problem. The ML models may be trained to identify images that exhibit the technical issue and provide those to the presentation module 116 for presentation to the media streaming entity 121. The image may be a clip of a movie or tv show or a still shot of a media streaming selection interface or other indicator of the technical issue. Providing a real-world example of the technical issue may be helpful in determining how to resolve the issue. As least in some cases, the ML models may be trained, over time, to identify images that are the best representation of the technical issue from among a plurality of different images that may show the issue to a smaller degree.

The user interface 600 may include another indicator of the technical issue (e.g., “Color distribution on [X] browser affecting video playback”). The user interface 600 may also provide a plain-language summary of the technical issue, which platforms are affected, which playback devices are affected, which error codes are related to the issue, which streaming plans are affected or involved, which A/B tests have been implemented for the user or the content, a total number of customer accounts reporting the technical issue, a cancellation rate indicating cancellations that can be tied to the issue, an amount of time spent on providing customer service, an indication of how relevant the issue is, or other information. The user interface 600 may be customized by customer service representatives or engineers to show data that is more pertinent to their individual needs. In this manner, the user interface 600 may provide extensive details about each technical issue that is experienced, as identified through natural language exchanges between customers and support teams.

At least in some cases, the plain-language summary may include not only a human-readable description of the technical issue related to the service that is to be resolved but may also include service consumption statistics 123 related to the specified issue. The service consumption statistics 123 may include an indication of which subscribed user is experiencing the technical issue, how long that subscriber has been a member, how many media items they have streamed without issue, which technical issues have arisen previously for that user, which device or devices the user typically uses to view content, which subscription plan the user has selected, indications of the user's location and/or internet connection speed, or other indications of who the user is or how the user has used the service in the past.

Any or all of this information may be used in conjunction with data extracted from natural language interactions between the service and other users to identify a technical issue for the user 119. The machine learning models may thus train on transcripts of past interactions, may ingest contextual information 109 and service consumption statistics 123 related to the user 119, and may combine the training and user information to identify a technical issue that is specific to the user 119. This tailored approach may provide a much more accurate assessment of user 119's specific technical issues as opposed to just determining a random user's technical issues with no background or usage information on the user.

In some embodiments, the machine learning model may be further trained to identify which service consumption statistics are most relevant for inclusion in the indication of the specified issue. As noted above, the service consumption statistics 123 may include many different statistics. Some of these statistics may be more or less relevant to a given user's technical issues. As such, the ML model training module 110 of computer system 101 may be configured to train the ML models 111 to learn, over time, which service consumption statistics 123 are most relevant to which clusters of technical issues. Each service consumption statistic 123 may shed more light on some issues than others. As such, the ML models may learn which statistics are most indicative of dark screen issues, for example, or playback interruptions, etc. In this manner, the system may continually implement those service consumption statistics 123 that are determined, over time, to be best for each cluster 114.

As noted above, the accessed data that includes natural language dialogue may come from a chat transcript or a voice transcript for a conversation between a user and an entity. In some cases, the chat transcripts or voice transcripts may be accessed from multiple different types of support interactions for the service. For instance, some support interactions may relate to the client playback application, while other interactions may relate to the client's playback device. Other customer support issues may surround the user interface, while other technical issues may relate to specific media items. The transcripts may thus come from many different types of customer support interactions.

Regardless of which type of interaction is analyzed, the ML models may be trained to map certain conversational cues to actual smartphone models or specific television hardware or, in some cases, to a list of likely candidate devices if the user isn't sure which device they are using. The ML models may use various clues in the user's spoken or written words to identify which type of device or which specific model or version the user 119 is using. The ML models may then list out which hardware components are likely being used for display and/or playback, and which technical issues may be associated with those hardware components. This may help to make identification of the technical issue much more accurate and, ideally, more helpful to the user and the entity.

At least in some embodiments, the machine learning model may be a large language model (LLM). The LLM may be artificial neural networks that are trained by ingesting large amounts of text and learning statistical relationships between various words and phrases. The LLMs may be trained to analyze previously written text as well as generate new text (e.g., generative artificial intelligence (AI)). In some cases, the process of generating structured data 112 that is assembled according to a specified schema 113 may first include determining how the LLM was trained.

For instance, some LLMs are trained in a certain manner to produce a certain result (e.g., generative AI, virtual assistant, etc.). Then, the process of generating the structured data may be altered based on how the LLM was trained. This may be referred to as a “teleological” approach in that the systems herein determine the purpose served by the LLM and alter the structured data based on the determined purpose. In this manner, an LLM will be selected that was trained with the purpose of parsing natural language dialogue and extracting those textual elements that are most helpful in identifying an underlying technical issue. The structured data will be altered to a form that the LLM has processed previously, either as input data or as a task run on the input data.

When the ML models are trained to structure, aggregate, and then map data to specific technical issues, the ML models may also be trained to determine a priority level for the technical issue. Some technical issues may be more pressing than others. Some may cause the client application to fail entirely or may cause playback to stop. Other issues may include color abnormalities or digital artifacts that, while distracting, do not stop the playback experience. Accordingly, the ML models may be trained, over time, to learn and predict the importance of an issue and assign a commensurate priority level to the technical issue. The entity 121 may then receive the indication of the technical issue that is to be resolved 117 and, with it, receive an indication of priority for each technical issue. This priority level may indicate to the entity how resources are to be allocated to the various technical issues, with higher priority issues receiving attention sooner than lower priority issues.

During the ML model training process, the ML models 111 may further be trained to filter noise from the natural language dialogue 108. Much of the conversational content between a customer and a customer service representative may be extraneous to the technical issue. Pleasantries, discussions about wait times and transfers to other departments, and other similar language can be identified as irrelevant or noise, at least in relation to the underlying technical issue(s). The ML models 111 may be trained, based on thousands or millions of natural language interactions, to identify content that is pertinent to the technical issues and content that is noise.

At the other end of the spectrum, the ML models may be trained to identify, from the natural language dialogue, which information is pertinent and which of that information is most important to a specific technical issue. In some cases, knowing which client device is experiencing the error is highly important to identifying the technical issue. As such, the ML model 111 may be trained to identify, from the natural language dialogue 108, which electronic device the user 119 is using. In such cases, the indication of the specified issue for resolution 117 may include an indication of a hardware-specific technical issue that is related to that specific electronic device.

In some cases, the machine learning models 111 may be further trained to determine how the technical issue is related to cancellations of the service. For instance, if the user 119 is subscribed to a service 120 provided by a media streaming entity, the technical issue they are experiencing may lead the user to cancel their subscription. If more subscribers cancel their subscriptions after experiencing a given technical issue, that issue may be assigned a higher priority for resolution. If multiple subscribers are experiencing the same technical issue and then canceling their service, that issue may be escalated quickly so that a resolution can be reached. In some cases, the ML models may be configured to analyze a specific timeframe after a given technical issue occurs to determine whether cancellations occur during that timeframe (e.g., one day, one week, one month, etc.). If multiple cancellations happen within that timeframe, they may be deemed to have been caused (at least partially) by the technical issue. This may raise the level of importance for resolving the issue.

In some cases, the technical issue may be named or identified by the entity 121. For instance, a specific technical issue may be mapped to a specific error code that is used by the service provider to identify a given error. This error code may then be included in the report generated by the presentation module 116. In such cases, the indication of the technical issue 117 may include the mapped error code and may further include various statistics related to the error code (e.g., the number of devices experiencing the issue, the number of people canceling service shortly after experiencing the issue, etc.), along with a plain-language summary of the technical issue generated by the machine learning model. This information may be used by the entity 121 to determine how to resolve the technical issue.

At least in some embodiments, the machine learning model 111 may be further trained to identify possible resolutions to the technical issue and to provide the possible resolutions to the entity 121. For instance, the machine learning model 111 may analyze many thousands or millions of previously identified technical issues and may match the eventual resolutions back to the technical issues. Based on this knowledge, the ML models may generate recommendations for responding to technical issues. These recommendations may include specific, predicted steps to take to resolve the technical issue. These steps may act as a guideline to help resolve the identified technical issues. The steps for resolution may be provided to engineering teams and may list specific errors that could be resolved. In other cases, the ML models may stop short of recommending a solution and may focus on identifying the technical issues that are being experienced by users of the service.

In addition to the above-described method, a system may be provided that includes at least one physical processor and physical memory comprising computer-executable instructions that, when executed by the physical processor, cause the physical processor to: access data that includes natural language dialogue gathered from a plurality of interactions between an entity and a user, wherein the user consumes a service provided by the entity, access contextual information related to the user, wherein the contextual information provides additional indications of the user's consumption of the service provided by the entity, train a machine learning model to generate structured data that is assembled according to a specified schema that prepares the structured data for aggregation into clusters, train the machine learning model to aggregate the data into clusters, wherein each cluster includes an identified standard that defines inclusion in the cluster, train the machine learning model to map the aggregated, structured data to a specified issue related to the service that is to be resolved and, based on the mapping, provide an indication of the specified issue that is to be resolved to at least one computing device.

Still further, in addition to the above-described method, a non-transitory computer-readable medium may be provided that includes one or more computer-executable instructions that, when executed by at least one processor of a computing device, cause the computing device to: access data that includes natural language dialogue gathered from a plurality of interactions between an entity and a user, wherein the user consumes a service provided by the entity, access contextual information related to the user, wherein the contextual information provides additional indications of the user's consumption of the service provided by the entity, train a machine learning model to generate structured data that is assembled according to a specified schema that prepares the structured data for aggregation into clusters, train the machine learning model to aggregate the data into clusters, wherein each cluster includes an identified standard that defines inclusion in the cluster, train the machine learning model to map the aggregated, structured data to a specified issue related to the service that is to be resolved and, based on the mapping, provide an indication of the specified issue that is to be resolved to at least one computing device.

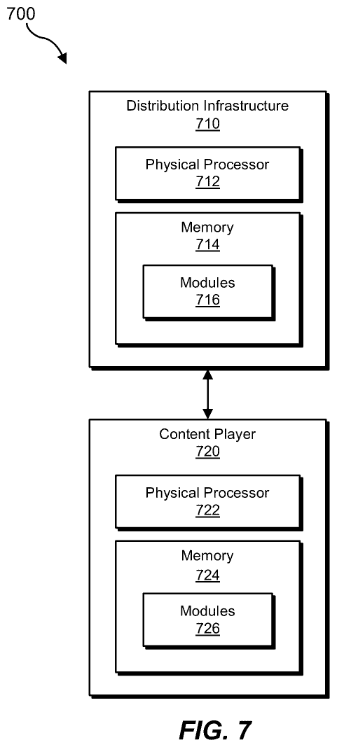

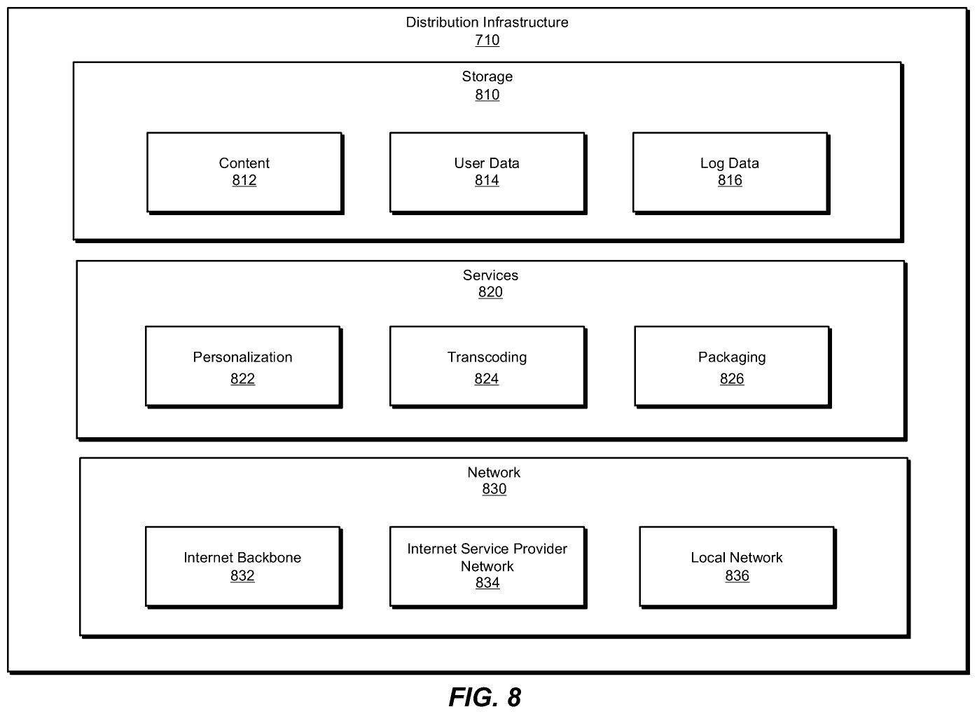

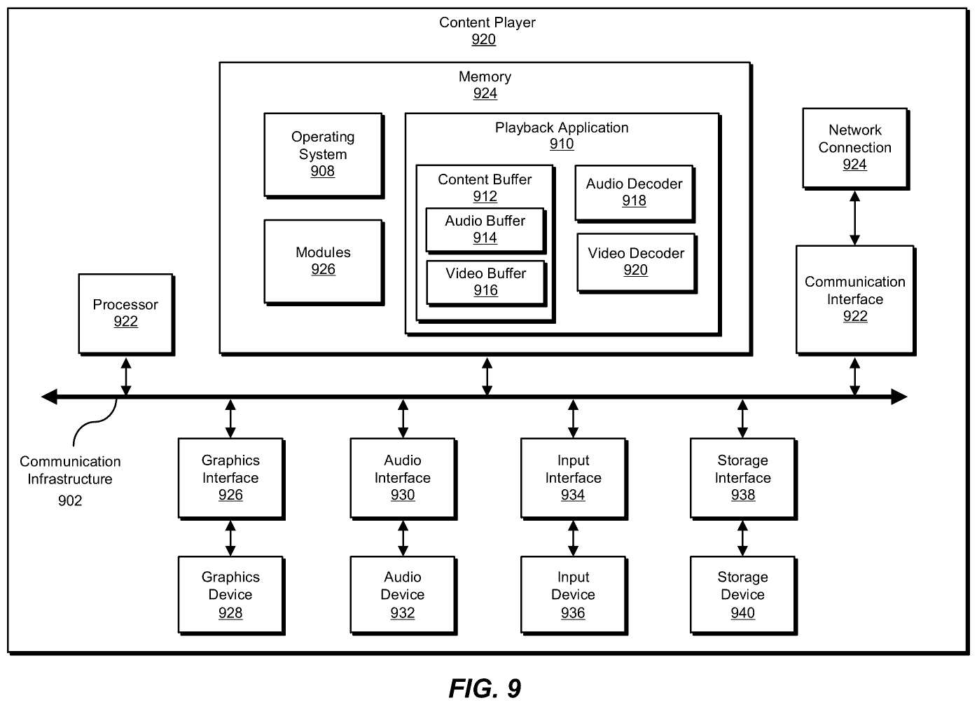

The following will provide, with reference to FIG. 7, detailed descriptions of exemplary ecosystems in which content is provisioned to end nodes and in which requests for content are steered to specific end nodes. The discussion corresponding to FIGS. 8 and 9 presents an overview of an exemplary distribution infrastructure and an exemplary content player used during playback sessions, respectively. These exemplary ecosystems and distribution infrastructures are implemented in any of the embodiments described above with reference to FIGS. 1-9.

FIG. 7 is a block diagram of a content distribution ecosystem 700 that includes a distribution infrastructure 710 in communication with a content player 720. In some embodiments, distribution infrastructure 710 is configured to encode data at a specific data rate and to transfer the encoded data to content player 720. Content player 720 is configured to receive the encoded data via distribution infrastructure 710 and to decode the data for playback to a user. The data provided by distribution infrastructure 710 includes, for example, audio, video, text, images, animations, interactive content, haptic data, virtual or augmented reality data, location data, gaming data, or any other type of data that is provided via streaming.

Distribution infrastructure 710 generally represents any services, hardware, software, or other infrastructure components configured to deliver content to end users. For example, distribution infrastructure 710 includes content aggregation systems, media transcoding and packaging services, network components, and/or a variety of other types of hardware and software. In some cases, distribution infrastructure 710 is implemented as a highly complex distribution system, a single media server or device, or anything in between. In some examples, regardless of size or complexity, distribution infrastructure 710 includes at least one physical processor 712 and at least one memory device 714. One or more modules 716 are stored or loaded into memory 714 to enable adaptive streaming, as discussed herein.

Content player 720 generally represents any type or form of device or system capable of playing audio and/or video content that has been provided over distribution infrastructure 710. Examples of content player 720 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 710, content player 720 includes a physical processor 722, memory 724, and one or more modules 726. Some or all of the adaptive streaming processes described herein is performed or enabled by modules 726, and in some examples, modules 716 of distribution infrastructure 710 coordinate with modules 726 of content player 720 to provide adaptive streaming of digital content.

In certain embodiments, one or more of modules 716 and/or 726 in FIG. 7 represent one or more software applications or programs that, when executed by a computing device, cause the computing device to perform one or more tasks. For example, and as will be described in greater detail below, one or more of modules 716 and 726 represent modules stored and configured to run on one or more general-purpose computing devices. One or more of modules 716 and 726 in FIG. 7 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 712 and 722 generally represent any type or form of hardware-implemented processing unit capable of interpreting and/or executing computer-readable instructions. In one example, physical processors 712 and 722 access and/or modify one or more of modules 716 and 726, respectively. Additionally or alternatively, physical processors 712 and 722 execute one or more of modules 716 and 726 to facilitate adaptive streaming of digital content. Examples of physical processors 712 and 722 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 714 and 724 generally represent any type or form of volatile or non-volatile storage device or medium capable of storing data and/or computer-readable instructions. In one example, memory 714 and/or 724 stores, loads, and/or maintains one or more of modules 716 and 726. Examples of memory 714 and/or 724 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 8 is a block diagram of exemplary components of content distribution infrastructure 710 according to certain embodiments. Distribution infrastructure 710 includes storage 810, services 820, and a network 830. Storage 810 generally represents any device, set of devices, and/or systems capable of storing content for delivery to end users. Storage 810 includes a central repository with devices capable of storing terabytes or petabytes of data and/or includes distributed storage systems (e.g., appliances that mirror or cache content at Internet interconnect locations to provide faster access to the mirrored content within certain regions). Storage 810 is also configured in any other suitable manner.

As shown, storage 810 may store a variety of different items including content 812, user data 814, and/or log data 816. Content 812 includes television shows, movies, video games, user-generated content, and/or any other suitable type or form of content. User data 814 includes personally identifiable information (PII), payment information, preference settings, language and accessibility settings, and/or any other information associated with a particular user or content player. Log data 816 includes viewing history information, network throughput information, and/or any other metrics associated with a user's connection to or interactions with distribution infrastructure 710.

Services 820 includes personalization services 822, transcoding services 824, and/or packaging services 826. Personalization services 822 personalize recommendations, content streams, and/or other aspects of a user's experience with distribution infrastructure 710. Encoding services 824 compress media at different bitrates which, as described in greater detail below, enable real-time switching between different encodings. Packaging services 826 package encoded video before deploying it to a delivery network, such as network 830, for streaming.

Network 830 generally represents any medium or architecture capable of facilitating communication or data transfer. Network 830 facilitates communication or data transfer using wireless and/or wired connections. Examples of network 830 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 8, network 830 includes an Internet backbone 832, an internet service provider 834, and/or a local network 836. As discussed in greater detail below, bandwidth limitations and bottlenecks within one or more of these network segments triggers video and/or audio bit rate adjustments.

FIG. 9 is a block diagram of an exemplary implementation of content player 720 of FIG. 7. Content player 720 generally represents any type or form of computing device capable of reading computer-executable instructions. Content player 720 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 9, in addition to processor 722 and memory 724, content player 720 includes a communication infrastructure 902 and a communication interface 922 coupled to a network connection 924. Content player 720 also includes a graphics interface 926 coupled to a graphics device 928, an input interface 934 coupled to an input device 936, and a storage interface 938 coupled to a storage device 940.

Communication infrastructure 902 generally represents any type or form of infrastructure capable of facilitating communication between one or more components of a computing device. Examples of communication infrastructure 902 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 724 generally represents any type or form of volatile or non-volatile storage device or medium capable of storing data and/or other computer-readable instructions. In some examples, memory 724 stores and/or loads an operating system 908 for execution by processor 722. In one example, operating system 908 includes and/or represents software that manages computer hardware and software resources and/or provides common services to computer programs and/or applications on content player 720.

Operating system 908 performs various system management functions, such as managing hardware components (e.g., graphics interface 926, audio interface 930, input interface 934, and/or storage interface 938). Operating system 908 also provides process and memory management models for playback application 910. The modules of playback application 910 includes, for example, a content buffer 912, an audio decoder 918, and a video decoder 920.

Playback application 910 is configured to retrieve digital content via communication interface 922 and play the digital content through graphics interface 926. Graphics interface 926 is configured to transmit a rendered video signal to graphics device 928. In normal operation, playback application 910 receives a request from a user to play a specific title or specific content. Playback application 910 then identifies one or more encoded video and audio streams associated with the requested title. After playback application 910 has located the encoded streams associated with the requested title, playback application 910 downloads sequence header indices associated with each encoded stream associated with the requested title from distribution infrastructure 710. A sequence header index associated with encoded content includes information related to the encoded sequence of data included in the encoded content.

In one embodiment, playback application 910 begins downloading the content associated with the requested title by downloading sequence data encoded to the lowest audio and/or video playback bitrates to minimize startup time for playback. The requested digital content file is then downloaded into content buffer 912, which is configured to serve as a first-in, first-out queue. In one embodiment, each unit of downloaded data includes a unit of video data or a unit of audio data. As units of video data associated with the requested digital content file are downloaded to the content player 720, the units of video data are pushed into the content buffer 912. Similarly, as units of audio data associated with the requested digital content file are downloaded to the content player 720, the units of audio data are pushed into the content buffer 912. In one embodiment, the units of video data are stored in video buffer 916 within content buffer 912 and the units of audio data are stored in audio buffer 914 of content buffer 912.

A video decoder 920 reads units of video data from video buffer 916 and outputs the units of video data in a sequence of video frames corresponding in duration to the fixed span of playback time. Reading a unit of video data from video buffer 916 effectively de-queues the unit of video data from video buffer 916. The sequence of video frames is then rendered by graphics interface 926 and transmitted to graphics device 928 to be displayed to a user.

An audio decoder 918 reads units of audio data from audio buffer 914 and outputs the units of audio data as a sequence of audio samples, generally synchronized in time with a sequence of decoded video frames. In one embodiment, the sequence of audio samples is transmitted to audio interface 930, which converts the sequence of audio samples into an electrical audio signal. The electrical audio signal is then transmitted to a speaker of audio device 932, which, in response, generates an acoustic output.

In situations where the bandwidth of distribution infrastructure 710 is limited and/or variable, playback application 910 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 926 is configured to generate frames of video data and transmit the frames of video data to graphics device 928. In one embodiment, graphics interface 926 is included as part of an integrated circuit, along with processor 722. Alternatively, graphics interface 926 is configured as a hardware accelerator that is distinct from (i.e., is not integrated within) a chipset that includes processor 722.

Graphics interface 926 generally represents any type or form of device configured to forward images for display on graphics device 928. For example, graphics device 928 is fabricated using liquid crystal display (LCD) technology, cathode-ray technology, and light-emitting diode (LED) display technology (either organic or inorganic). In some embodiments, graphics device 928 also includes a virtual reality display and/or an augmented reality display. Graphics device 928 includes any technically feasible means for generating an image for display. In other words, graphics device 928 generally represents any type or form of device capable of visually displaying information forwarded by graphics interface 926.

As illustrated in FIG. 9, content player 720 also includes at least one input device 936 coupled to communication infrastructure 902 via input interface 934. Input device 936 generally represents any type or form of computing device capable of providing input, either computer or human generated, to content player 720. Examples of input device 936 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Content player 720 also includes a storage device 940 coupled to communication infrastructure 902 via a storage interface 938. Storage device 940 generally represents any type or form of storage device or medium capable of storing data and/or other computer-readable instructions. For example, storage device 940 is a magnetic disk drive, a solid-state drive, an optical disk drive, a flash drive, or the like. Storage interface 938 generally represents any type or form of interface or device for transferring data between storage device 940 and other components of content player 720.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

### EXAMPLE EMBODIMENTS

### Example 1

A computer-implemented method comprising: accessing data that includes natural language dialogue gathered from a plurality of interactions between an entity and a user, wherein the user consumes a service provided by the entity, accessing contextual information related to the user, wherein the contextual information provides additional indications of the user's consumption of the service provided by the entity, training a machine learning model to generate structured data that is assembled according to a specified schema that prepares the structured data for aggregation into clusters, training the machine learning model to aggregate the data into clusters, wherein each cluster includes an identified standard that defines inclusion in the cluster, training the machine learning model to map the aggregated, structured data to a specified technical issue related to the service that is to be resolved and, based on the mapping, providing an indication of the specified technical issue that is to be resolved to at least one computing device.

### Example 2

The computer-implemented method of Example 1, wherein the indication of the specified technical issue that is to be resolved comprises a human-readable description of the technical issue related to the service that is to be resolved.

### Example 3

The computer-implemented method of Example 1 or Example 2, wherein the indication of the specified technical issue that is to be resolved further includes a plurality of service consumption statistics related to the specified technical issue.

### Example 4

The computer-implemented method of any of Examples 1-3, wherein the machine learning model is further trained to identify which service consumption statistics are most relevant for inclusion in the indication of the specified technical issue.

### Example 5

The computer-implemented method of any of Examples 1-4, wherein the accessed data that includes natural language dialogue comprises a chat transcript or a voice transcript.

### Example 6

The computer-implemented method of any of Examples 1-5, wherein the chat transcripts or voice transcripts are accessed from a plurality of different types of support interactions for the service.

### Example 7

The computer-implemented method of any of Examples 1-6, wherein the machine learning model comprises a large language model (LLM).

### Example 8

The computer-implemented method of any of Examples 1-7, wherein generating the structured data includes determining how the LLM has been trained and altering the structured data based on the determination.

### Example 9

The computer-implemented method of any of Examples 1-8, wherein the structured data is altered to a form that the LLM has processed previously as input data or as a task run on the input data.

### Example 10

The computer-implemented method of any of Examples 1-9, wherein the indication of the specified technical issue that is to be resolved further includes an indication of priority for the technical issue.

### Example 11

The computer-implemented method of any of Examples 1-10, wherein the machine learning model is further trained to filter noise from the natural language dialogue.

### Example 12

The computer-implemented method of any of Examples 1-11, wherein the machine learning model is further trained to identify, from the natural language dialogue, which electronic device the user is using, and wherein the indication of the specified technical issue includes an indication of a hardware-specific technical issue related to the identified electronic device.

### Example 13

A system comprising at least one physical processor and physical memory comprising computer-executable instructions that, when executed by the physical processor, cause the physical processor to: access data that includes natural language dialogue gathered from a plurality of interactions between an entity and a user, wherein the user consumes a service provided by the entity, access contextual information related to the user, wherein the contextual information provides additional indications of the user's consumption of the service provided by the entity, train a machine learning model to generate structured data that is assembled according to a specified schema that prepares the structured data for aggregation into clusters, train the machine learning model to aggregate the data into clusters, wherein each cluster includes an identified standard that defines inclusion in the cluster, train the machine learning model to map the aggregated, structured data to a specified technical issue related to the service that is to be resolved and, based on the mapping, provide an indication of the specified technical issue that is to be resolved to at least one computing device.

### Example 14

The system of Example 13, wherein the machine learning model is further trained to determine how the specified technical issue is related to cancellations of the service.

### Example 15

The system of Example 14, wherein the machine learning model analyzes a specified timeframe after the technical issue occurs to determine whether cancellations occur during that timeframe.

### Example 16

The system of Example 14 or Example 15, wherein the specified technical issue is mapped to an error code used by the service to identify a specific error.

### Example 17

The system of any of Examples 14-16, wherein the indication of the specified technical issue includes the mapped error code, one or more statistics related to the error code, and a plain-language summary of the technical issue generated by the machine learning model.

### Example 18

The system of Examples 14-17, wherein the machine learning model is further trained to identify at least one possible resolution to the specified technical issue.

### Example 19

The system of any of Examples 14-18, further comprising providing the identified at least one possible resolution to the entity.

### Example 20

A non-transitory computer-readable medium comprising one or more computer-executable instructions that, when executed by at least one processor of a computing device, cause the computing device to: access data that includes natural language dialogue gathered from a plurality of interactions between an entity and a user, wherein the user consumes a service provided by the entity, access contextual information related to the user, wherein the contextual information provides additional indications of the user's consumption of the service provided by the entity, train a machine learning model to generate structured data that is assembled according to a specified schema that prepares the structured data for aggregation into clusters, train the machine learning model to aggregate the data into clusters, wherein each cluster includes an identified standard that defines inclusion in the cluster, train the machine learning model to map the aggregated, structured data to a specified technical issue related to the service that is to be resolved and, based on the mapping, provide an indication of the specified technical issue that is to be resolved to at least one computing device.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
accessing data that includes natural language dialogue gathered from a plurality of interactions between an entity and a user, wherein the user consumes a service provided by the entity;
accessing contextual information related to the user, wherein the contextual information provides additional indications of the user's consumption of the service provided by the entity;
training a machine learning model to generate structured data that is assembled according to a specified schema that prepares the structured data for aggregation into clusters;
training the machine learning model to aggregate the data into clusters, wherein each cluster includes an identified standard that defines inclusion in the cluster;
training the machine learning model to map the aggregated, structured data to a specified technical issue related to the service that is to be resolved; and
based on the mapping, providing an indication of the specified technical issue that is to be resolved to at least one computing device.

2. The computer-implemented method of claim 1, wherein the indication of the specified technical issue that is to be resolved comprises a human-readable description of the technical issue related to the service that is to be resolved.

3. The computer-implemented method of claim 2, wherein the indication of the specified technical issue that is to be resolved further includes a plurality of service consumption statistics related to the specified technical issue.

4. The computer-implemented method of claim 3, wherein the machine learning model is further trained to identify which service consumption statistics are most relevant for inclusion in the indication of the specified technical issue.

5. The computer-implemented method of claim 1, wherein the accessed data that includes natural language dialogue comprises a chat transcript or a voice transcript.

6. The computer-implemented method of claim 5, wherein the chat transcripts or voice transcripts are accessed from a plurality of different types of support interactions for the service.

7. The computer-implemented method of claim 1, wherein the machine learning model comprises a large language model (LLM).

8. The computer-implemented method of claim 7, wherein generating the structured data includes determining how the LLM has been trained and altering the structured data based on the determination.

9. The computer-implemented method of claim 8, wherein the structured data is altered to a form that the LLM has processed previously as input data or as a task run on the input data.

10. The computer-implemented method of claim 1, wherein the indication of the specified technical issue that is to be resolved further includes an indication of priority for the technical issue.

11. The computer-implemented method of claim 1, wherein the machine learning model is further trained to filter noise from the natural language dialogue.

12. The computer-implemented method of claim 1, wherein the machine learning model is further trained to identify, from the natural language dialogue, which electronic device the user is using, and wherein the indication of the specified technical issue includes an indication of a hardware-specific technical issue related to the identified electronic device.

13. A system comprising:
at least one physical processor;
an electronic display; and
physical memory comprising computer-executable instructions that, when executed by the physical processor, cause the physical processor to:
access data that includes natural language dialogue gathered from a plurality of interactions between an entity and a user, wherein the user consumes a service provided by the entity;
access contextual information related to the user, wherein the contextual information provides additional indications of the user's consumption of the service provided by the entity;
train a machine learning model to generate structured data that is assembled according to a specified schema that prepares the structured data for aggregation into clusters;
train the machine learning model to aggregate the data into clusters, wherein each cluster includes an identified standard that defines inclusion in the cluster;
train the machine learning model to map the aggregated, structured data to a specified technical issue related to the service that is to be resolved; and
based on the mapping, provide an indication of the specified technical issue that is to be resolved to at least one computing device.

14. The system of claim 13, wherein the machine learning model is further trained to determine how the specified technical issue is related to cancellations of the service.

15. The system of claim 14, wherein the machine learning model analyzes a specified timeframe after the technical issue occurs to determine whether cancellations occur during that timeframe.

16. The system of claim 13, wherein the specified technical issue is mapped to an error code used by the service to identify a specific error.

17. The system of claim 16, wherein the indication of the specified technical issue includes the mapped error code, one or more statistics related to the error code, and a plain-language summary of the technical issue generated by the machine learning model.

18. The system of claim 13, wherein the machine learning model is further trained to identify at least one possible resolution to the specified technical issue.

19. The system of claim 18, further comprising providing the identified at least one possible resolution to the entity.

20. A non-transitory computer-readable medium comprising one or more computer-executable instructions that, when executed by at least one processor of a computing device, cause the computing device to:
access data that includes natural language dialogue gathered from a plurality of interactions between an entity and a user, wherein the user consumes a service provided by the entity;
access contextual information related to the user, wherein the contextual information provides additional indications of the user's consumption of the service provided by the entity;
train a machine learning model to generate structured data that is assembled according to a specified schema that prepares the structured data for aggregation into clusters;
train the machine learning model to aggregate the data into clusters, wherein each cluster includes an identified standard that defines inclusion in the cluster;
train the machine learning model to map the aggregated, structured data to a specified technical issue related to the service that is to be resolved; and
based on the mapping, provide an indication of the specified technical issue that is to be resolved to at least one computing device.
